(19) United States
(12) Patent Application Publication
(10) Pub. No.: US 2018/0120457 A1
(43) Pub. Date: May 3, 2018

(54) RADIOGRAPHING SYSTEM, RADIATION DISPLAY METHOD, AND STORAGE MEDIUM

(71) Applicant: CANON KABUSHIKI KAISHA, Tokyo (JP)

(72) Inventors: Osamu Tsujii, Kawasaki-shi (JP); Yoshinori Hirano, Kashiwa-shi (JP)

(21) Appl. No.: 15/792,224

(22) Filed: Oct. 24, 2017

(30) Foreign Application Priority Data
Oct. 28, 2016 (JP) 2016-212127

(51) Int. Cl. G01T 1/24

(52) U.S. Cl. CPC G01T 1/247

(57) ABSTRACT

A radiographing system includes a radiation detection apparatus that detects radiation that passed through a subject and outputs image data, a spatial statistical processing unit that acquires an average pixel value and a variance value of a predetermined pixel based on the image data and performs a spatial statistical process, a time statistical processing unit that acquires an average pixel value and a variance value in a time-series manner based on a plurality of image data and performs a time statistical process, and a display unit that displays a spatial statistical image based on spatial statistical information or a time statistical image based on time statistical information.

### BACKGROUND OF THE INVENTION

### Field

The present disclosure relates to a radiographing system, a radiation display method, and a storage medium. In particular, to a technique for identifying constitutive substances of a subject.

### Description of the Related Art

There is known a radiographing system using a flat panel detector (FPD) formed from a semiconductor material. The radiographing system can shoot radiographic images, including still images and moving images. The FPD measures the total amount of electric charges generated by incident radiation.

There has been proposed a radiographing system that calculates the average value and variance value of pixel values in each predetermined area to estimate the radiation quantum number and the average value of energy (for example, refer to Japanese Patent Laid-Open No. 2009-285356). According to Japanese Patent Laid-Open No. 2009-285356, however, with, for example, an abrupt change in the density of an image, the estimated radiation quantum number and average value of energy can include major errors.

### SUMMARY

An aspect of the present disclosure provides a radiographing system that displays statistical images based on appropriate statistical processes, a radiation display method, and a storage medium. The radiographing system includes a radiation detection apparatus that detects radiation that passed through a subject and outputs image data, a spatial statistical processing unit that acquires an average pixel value and a variance value of a predetermined pixel based on the image data and performs a spatial statistical process, a time statistical processing unit that acquires an average pixel value and a variance value in a time-series manner based on a plurality of image data and performs a time statistical process, and a display unit that displays a spatial statistical image based on spatial statistical information that is a result of the spatial statistical process or a time statistical image based on time statistical information that is a result of the spatial statistical process.

Further features will become apparent from the following description of exemplary embodiments with reference to the attached drawings.

### BRIEF DESCRIPTION OF THE DRAWINGS

FIG. 1 is a diagram illustrating a configuration of a radiographing system.

FIG. 2 is a diagram illustrating a time statistical process.

FIG. 3 is a diagram illustrating a spatial statistical process.

FIGS. 4A and 4B are diagrams illustrating examples of display forms on a display unit.

FIG. 5 is a diagram illustrating an example of a display form on the display unit.

FIGS. 6A, 6B, 6C, and 6D are diagrams illustrating an example of an operation sequence.

FIGS. 7A, 7B, 7C, and 7D are diagrams illustrating an example of an operation sequence.

FIGS. 8A, 8B, 8C, and 8D are diagrams illustrating an example of an operation sequence.

FIGS. 9A, 9B, 9C, 9D, and 9E are diagrams illustrating an example of an operation sequence.

FIG. 10 is a diagram illustrating an example of a setting screen on the display unit.

FIG. 11 is a diagram illustrating an example of a setting screen on the display unit.

FIG. 12 is a diagram illustrating an example of a setting screen on the display unit.

FIG. 13 is a diagram illustrating an example of a setting screen on the display unit.

### DESCRIPTION OF THE EMBODIMENTS

Exemplary embodiments will be described with reference to the attached drawings.

### First Embodiment

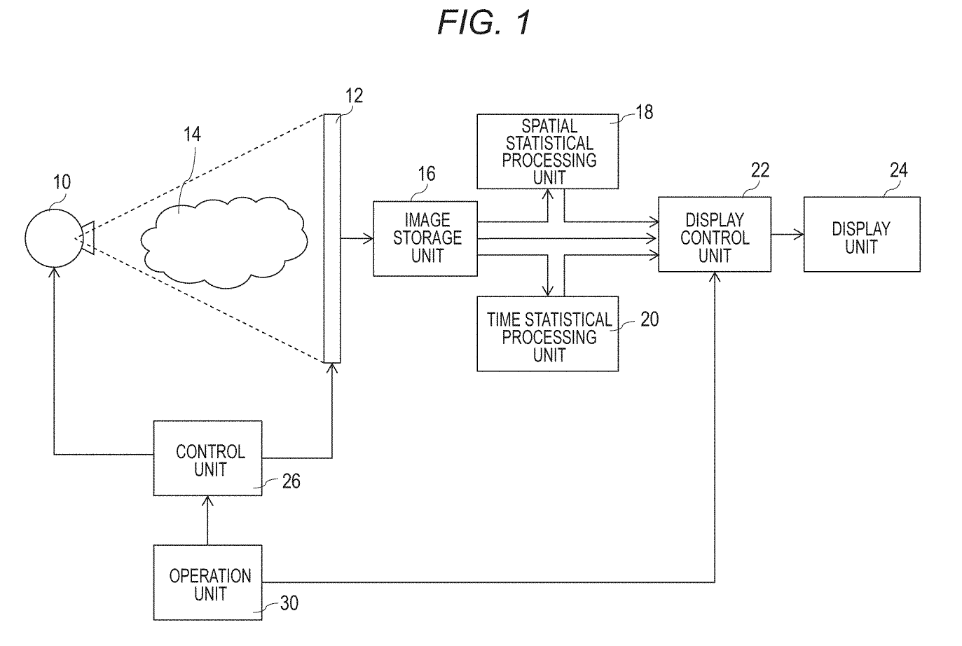

As illustrated in FIG. 1, a radiographing system performing radiographing is installed in an imaging room. In addition, a radiation generation unit 10 generating radiation, a radiation detection apparatus 12 detecting radiation that passed through a subject 14, and an imaging table (not illustrated) supporting the radiation detection apparatus 12 are installed in the imaging room.

The radiographing system includes an image storage unit 16 that stores radiation images based on the radiation detected by the radiation detection apparatus 12, a spatial statistical processing unit 18 that acquires an average pixel value and a variance value in each of a plurality of pixel areas and calculates radiation quantum number and average energy, and a time statistical processing unit 20 that acquires an average pixel value and a variance value in each pixel in a time-series manner and calculates radiation quantum number and average energy. That is, the radiographing system can generate a plurality of types of statistical images.

The radiographing system includes a display control unit 22 that controls display of a spatial statistical image based on spatial statistical information processed by the spatial statistical processing unit 18 and a time statistical image based on time statistical information processed by the time statistical processing unit 20. In addition, the radiographing system includes a display unit 24 that displays the spatial statistical image based on the spatial statistical information, the time statistical image based on the time statistical information, or a radiation image based on radiation.

The radiographing system includes an operation unit 30 for an operator to perform an operation and a control unit 26 that controls the radiation generation unit 10 and the radiation detection apparatus 12.

The control unit 26 is connected to the radiation generation unit 10 via a cable. The control unit 26 sets radiographing conditions (tube voltage, tube current, and irradiation time) in the radiation generation unit 10 to control the radiation generation unit 10. The radiation generation unit 10 acts as a radiation source that generates radiation. The radiation generation unit 10 is implemented by a radiation X-ray tube, for example, and emits radiation to the subject 14, e.g., a specific part of the subject.

The radiation generation unit 10 can emit radiation to a desired irradiation area. The radiation generation unit 10 is installed via a support unit (not illustrated) on a floor surface or a ceiling. The irradiation surface of the radiation generation unit 10 includes a diaphragm (not illustrated) that shields radiation. The operator can control the diaphragm shielding radiation to set the irradiation area of the radiation emitted from the radiation generation unit 10.

The radiographing system includes a radiation detection apparatus 12 that detects the radiation emitted from the radiation generation unit 10 and that penetrated the subject 14. The radiation detection apparatus 12 detects the radiation that passed through the subject 14 and outputs image data according to the radiation. The image data can also be called radiation image.

Specifically, the radiation detection apparatus 12 detects the radiation that passed through the subject 14 as electric charges equivalent to the penetrating radiation dose. For example, the radiation detection apparatus 12 is a direct conversion-type sensor, such as a-Se, that converts radiation directly into electric charges or an indirect-type sensor that uses a scintillator, such as CsI and a photoelectric conversion element such as a-Si. The radiation detection apparatus 12 also subjects the detected electric charges to A/D conversion to generate image data, and outputs the image data to the image storage unit 16.

The operation unit 30 operates a process in the radiographing system and transfers the contents of the operation to the control unit 26 and the display control unit 22. The display unit 24 is implemented by, for example, a liquid crystal display that displays various information for an operator, e.g., radiographing technician or doctor. The operation unit 30 is, for example, a mouse, operation buttons, or the like. The display unit 24 and the operation unit 30 can be implemented as a touch panel in which the display unit 24 and the operation unit 30 are integrated.

The control unit 26 is connected to the radiation detection apparatus 12 via a cable. The control unit 26 and the radiation detection apparatus 12 exchange power source, image data, control signals, and the like with each other via the cable. The radiation detection apparatus 12 detects the radiation that passed through the subject 14 and acquires a radiation image (image data) based on the subject 14. That is, the radiation generation unit 10 and the radiation detection apparatus 12 cooperate to perform radiographing.

### <Time Statistical Process>

The time statistical process by the time statistical processing unit 20 will now be described. The time statistical processing unit 20 acquires the average pixel value and variance value of each pixel in the radiation image in a time-series manner and estimates the radiation quantum number and average energy.

The radiation detection apparatus 12 includes a scintillator that converts radiation photons into visible light photons, a photoelectric conversion element that converts the visible light photons into electric charges, and an output circuit that converts a voltage with the converted electric charges into a digital signal and outputs the same. When the scintillator absorbs the radiation photons as an example of radiation quanta, the scintillator generates radiation photons. The number of the visible light photons generated at that time varies depending on the energy of the radiation photons absorbed by the scintillator. Specifically, the greater the energy of the radiation photons, the more the visible light photons are generated in the scintillator. The amount of electric charges depending on the number of the electric charges generated by the photoelectric conversion element is determined based on the number of the visible light photons absorbed by the photoelectric conversion element. The value of the digital signal finally output from the radiation detection apparatus is determined by subjecting the value of the analog voltage with the converted amount of electric charges to the analog/digital conversion. For example, the value of the digital signal output based on the radiation photons with specific energy is 30 LSB, and the value of the digital signal output based on the radiation photons with higher energy is 100 LSB. Therefore, each time the scintillator absorbs one radiation photon, the digital signal based on the amount of electric charges generated by the photoelectric conversion element can be acquired to identify the energy of the radiation photon from the value. In this case, LSB is the quantization unit of the analog/digital conversion, and 30 LSB means 30 quantization units.

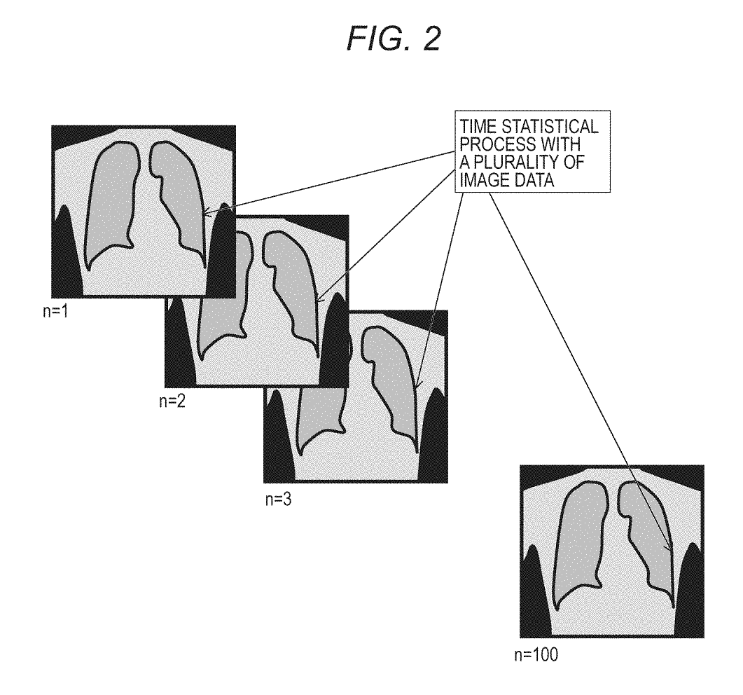

The principles of estimating the average value of energy of radiation quanta will now be described. FIG. 2 is a conceptual diagram for describing the principles of estimating the average value of energy of radiation quanta. Referring to FIG. 2, the radiation detection apparatus 12 is exposed to radiation a plurality of number of times via the subject 14 for a predetermined period of time to acquire a plurality of (n) image data. FIG. 2 illustrates a time series in which an arbitrary one of pixels is selected from the obtained image data and a digital signal (hereinafter, called pixel value) is obtained from the selected pixel. The time series of the pixel value includes variations. The variations include quantum noise.

The quantum noise results from variations in the quantum number of the radiation quanta, e.g., the number of radiation photons, per unit time. When being regarded as occurrence probability of discrete events per unit time, the variations in the quantum number of radiation quanta are pursuant to Poisson distribution as discrete probability distribution having a specific random variable for counting discrete events occurring at predetermined time intervals. In the Poisson distribution, when the random variable taking a value of a natural number satisfies a desired condition with a constant λ>0, the random variable is pursuant to the Poisson distribution of parameter λ.

For example, when the expected value of the quantum number of the radiation quanta applied to an arbitrary pixel per unit time is 10, the quantum number of the radiation quanta actually applied to an arbitrary pixel per unit time varies among values such as 12, 5, 13, 11, . . . . In such a case, as in the foregoing example, when the value of the digital signal output according to one radiation quantum with specific energy is 30 LSB, the actual pixel value varies among values such as 360 LSB, 150 LSB, 390 LSB, 330 LSB . . . . In the case of such an example, when the sample number as the number of the acquired pixel values is increased infinitely, the expected pixel value is 300 LSB, and the value of the variation (hereinafter, called variance) is 9000 LSB.

In addition, for example, it is assumed that the expected value of the quantum number of the radiation quanta applied to an arbitrary pixel per unit time is 3 and the value of the digital signal output according to one radiation quantum with specific energy is 100 LSB. In this case, when the sample number is increased infinitely, the expected pixel value is 300 LSB and the value of variation (hereinafter, called variance) is 30000 LSB.

That is, even with the same average of the pixel value, the image formed from the radiation quanta with larger energy has wider variance of pixel values than the image formed from the radiation quanta with smaller energy. With the use of this phenomenon, it is possible to estimate the energy of radiation quanta, such as radiation photons.

A method for estimating the energy of radiation quanta using equations will now be described. First, the radiation detection apparatus is exposed to radiation T (T is a natural number of greater than or equal to 2) times to acquire image data of T images from the radiation detection apparatus. When the pixel value of one pixel in the t-th (t is a natural number greater than or equal to 2 and less than or equal to T) image data is designated as I(t), the total number of the quantum numbers of the radiation quanta having reached and been absorbed by the pixel is designated as N, and the energy of the radiation quanta is designated as E, Equation (1) can be established as follows:

E×N=ΣI(t) (1)

When the arithmetic average of the quantum numbers of the radiation quanta having reached and been absorbed by the pixel of one pixel data calculated by Equation (1) is designated as n_{Ave}, n_{Ave} can be expressed by Equation (2) as follows:

n_{Ave}=N/T=Σ/(t)/E/T (2)

When the sample variance of the quantum numbers of the radiation quanta having reached and been absorbed by the pixel of one pixel data calculated by Equation (1) is designated as n_{Var}, n_{Var} can be expressed by Equation (3) as follows:

n_{Var}=Σ[{I(t)/E−n_{Ave}}²]/T (3)

In the Poisson distribution, the estimated value and the variance are equal to the parameter λ. In addition, as the number of samples is increased, the arithmetic average comes closer to the estimated value and the sample variance comes closer to the variance. Accordingly, when the number of samples is sufficiently large (preferably, infinity) and the arithmetic average n_{Ave} of the quantum numbers of the radiation quanta and the sample variance n_{Var} of the quantum numbers of the radiation quanta are regarded as equal and approximated, Equation (4) can be derived based on the assumption that Equation (2) and Equation (3) are equal as follows:

E=τ{I(t)²}/I(t)t)}−τ/I(t)t)} (4)

In this way, the energy E of the radiation quanta having reached and been absorbed by an arbitrary pixel in the t-th image data can be estimated from the pixel value I(t) of the pixel.

When the arithmetic average of the pixel value I(t) is designated as I_{Ave}, the arithmetic average I_{Ave} of the pixel value I(t) can be expressed by Equation (5) using the arithmetic average n_{Ave} of the quantum numbers of the radiation quanta as follows:

I_{Ave}=n_{Ave}×E (5)

When the sample variance of the pixel value is designated as I_{Var}, the sample variance I_{Var} of the pixel value can be expressed from the sample variance n_{Var} of the quantum numbers of the radiation quanta by Equation (6) as follows:

I_{Var}=n_{Var}×E² (6)

Therefore, the energy E of the radiation quanta having reached and been absorbed by the pixel can also be expressed by Equation (7) as follows:

E=I_{Var}/I_{Ave} (7)

In actuality, the energy of the radiation quanta having reached and been absorbed by the pixel is not single. For example, when the radiation is generated by a general radiation generation apparatus under a tube voltage of 100 kV, radiation photons with various types of energy of 100 KeV or less can be generated. For such radiation, the average value of energy of the radiation quanta having reached and been absorbed by the pixel can be estimated by approximation on the assumption that Equation (4) can hold. In addition, the number of the radiation quanta can be estimated using Equation (1) from the average value of energy of the radiation quanta and the pixel value I(t) of an arbitrary pixel in the t-th image data. In this case, the estimation process by the time statistical processing unit 20 is called time statistical process.

### <Spatial Statistical Process>

The spatial statistical process performed by the spatial statistical processing unit 18 will now be described. The spatial statistical processing unit 18 estimates the radiation quantum number and the average energy using the average pixel value and variance value in each predetermined area of a radiation image. In this case, the predetermined area is set on the periphery of a pixel in which the average energy is to be estimated, and the radiation quantum number and the average energy are estimated on the assumption that the radiation energy is uniform.

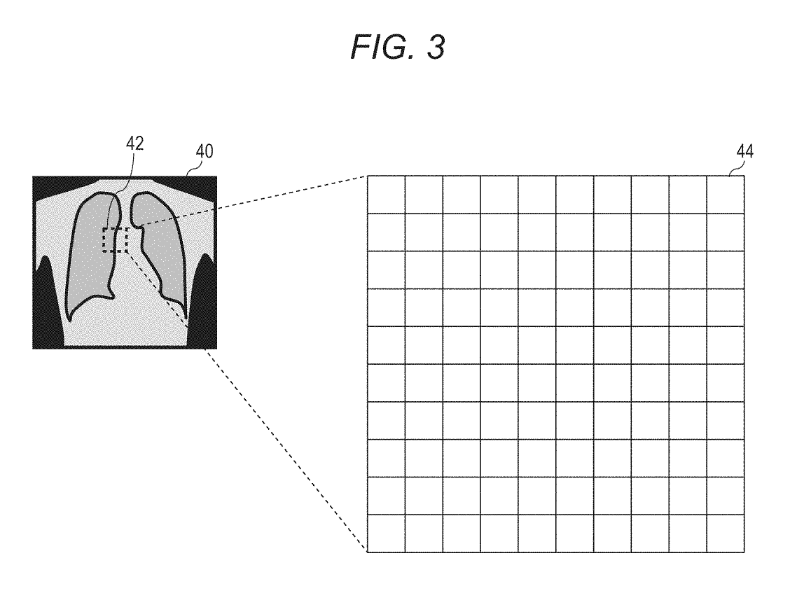

For example, as illustrated in FIG. 3, the spatial statistical processing unit 18 estimates the radiation quantum number and the average energy in a predetermined area 42 of a radiation image 40. The predetermined area 42 has a pixel range 44 of 10×10 pixels for the spatial statistical process. That is, the spatial statistical processing unit 18 calculates the average pixel value and variance value in the pixel range 44 and estimates the radiation quantum number and average energy. In this case, the estimation process performed by the spatial statistical processing unit 18 is called spatial statistical process.

The spatial statistical processing unit 18 can arbitrarily set the pixel range 44 in the predetermined area 42 to 5×5 pixels, 3×3 pixels, or the like for the spatial statistical process. The spatial statistical processing unit 18 can estimate the radiation quantum number and the average energy for one each pixel.

### <Display>

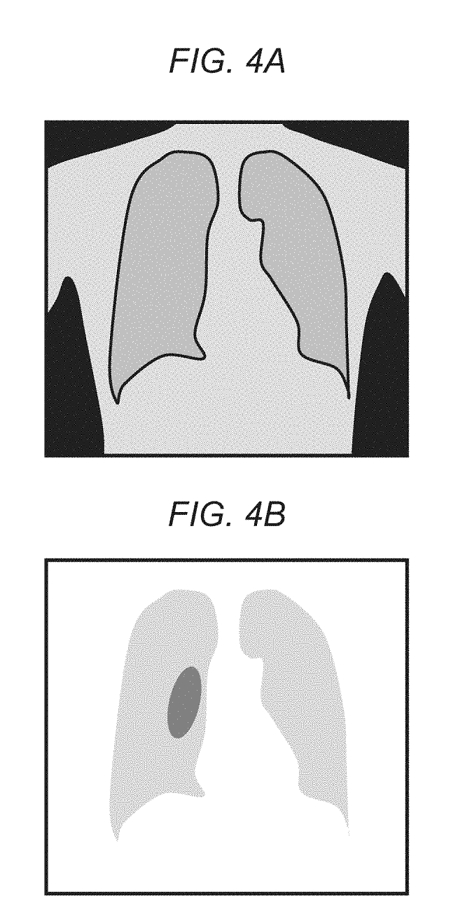

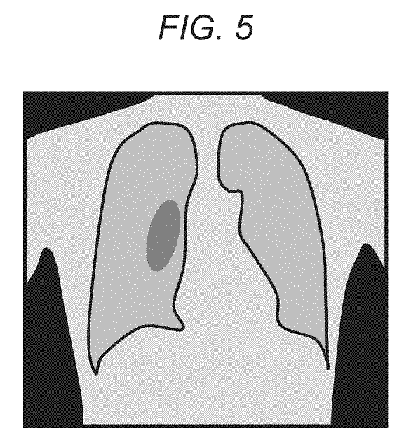

The display form on the display unit 24 will now be described with reference to FIGS. 4 and 5. The display control unit 22 performs display control of a spatial statistical image based on the spatial statistical process performed by the spatial statistical processing unit 18 and a time statistical image based on the time statistical process performed by the time statistical processing unit 20, and displays these images on the display unit 24.

As illustrated in FIG. 4, the display unit 24 displays either the spatial statistical image based on the spatial statistical process performed by the spatial statistical processing unit 18 or the time statistical image based on the time statistical process performed by the time statistical processing unit 20, in parallel to a radiation image. The radiation image is an image generated from image data based on the radiation detected by the radiation detection apparatus 12.

FIG. 4A illustrates the radiation image. FIG. 4B illustrates the spatial statistical image based on the spatial statistical process or the time statistical image based on the time statistical process. In this case, the display unit 24 displays either the spatial statistical image or the time statistical image. The display unit 24 can display the spatial statistical image or the time statistical image equal in size to the radiation image.

In addition, as illustrated in FIG. 5, the display unit 24 can display either the spatial statistical image based on the spatial statistical process performed by the spatial statistical processing unit 18 or the time statistical image based on the time statistical process performed by the time statistical processing unit 20 to superimpose on the radiation image based on the radiation.

In this way, the operator can compare the radiation image based on the spatial statistical information or the time statistical image based on the time statistical information with the radiation image including morphologic information about the subject 14. Accordingly, the operator can add information about the constitutive substances of the subject 14 acquired from the spatial statistical image or the time statistical image to a hard-to-distinguish area of the radiation image acquired by radiographing.

### <Sequence>

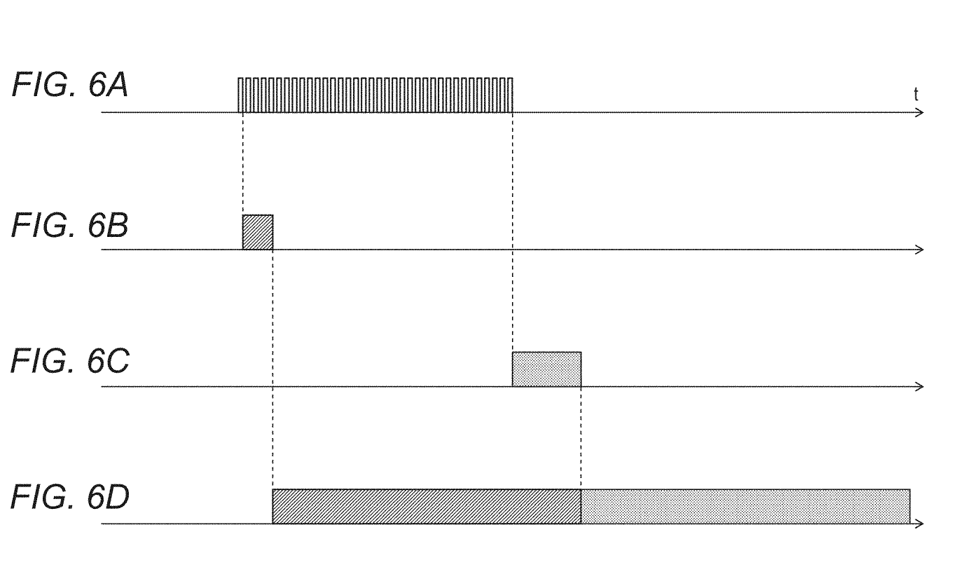

The sequence of statistical process and display according to the first embodiment will be described with reference to FIGS. 6A, 6B, 6C, and 6D. FIG. 6A illustrates the timing for acquiring the image data output from the radiation detection apparatus 12. FIG. 6B illustrates the timing for acquiring the spatial statistical image based on the spatial statistical information. FIG. 6C illustrates the timing for acquiring the time statistical image based on the time statistical information. FIG. 6D illustrates the timing for displaying the image to be displayed on the display unit 24.

As illustrated in FIG. 6B, the spatial statistical processing unit 18 can perform the spatial statistical process with one image data, and once image data is output, the spatial statistical processing unit 18 immediately performs the spatial statistical process. At that time, as illustrated in FIG. 6C, the time statistical process performed by the time statistical processing unit requires a plurality of image data, and the time statistical processing unit 20 cannot perform the time statistical process.

Upon completion of the spatial statistical process performed by the spatial statistical processing unit 18, the spatial statistical processing unit 18 outputs the spatial statistical image based on the spatial statistical process. The display control unit 22 controls the display unit 24 to display the spatial statistical image output from the spatial statistical processing unit 18. The display unit 24 displays the spatial statistical image.

When the spatial statistical processing unit 18 repeatedly performs the spatial statistical process, the spatial statistical processing unit 18 outputs a spatial statistical image based on each spatial statistical process. The display control unit 22 controls the display unit 24 to display the latest spatial statistical image output from the spatial statistical processing unit 18. The display unit 24 displays the latest spatial statistical image output from the spatial statistical processing unit 18.

As illustrated in FIG. 6C, upon completion of the time statistical process performed by the time statistical processing unit 20, the time statistical processing unit 20 outputs the time statistical image based on the time statistical process. The display control unit 22 controls the display unit 24 to display the time statistical image output from the time statistical processing unit 20. The display unit 24 displays the time statistical image.

At that time, as illustrated in FIG. 6D, the display unit 24 displays the time statistical image after the display unit 24 displays the spatial statistical image. In this case, the spatial statistical image is deleted from the display unit 24 and the time statistical image is displayed on the display unit 24. For the spatial statistical image, the radiation quantum number and average energy are estimated using the average pixel value and variance value in each predetermined area of the image data, and therefore the time statistical image is higher in image resolution than the spatial statistical image. Therefore, in the embodiment, the spatial statistical image is replaced by the time statistical image on the display unit 24.

### <Body Motion>

The spatial statistical process performed by the spatial statistical processing unit 18 and the time statistical process performed by the time statistical processing unit 20 are controlled based on the body motion of the subject 14. Information about the body motion of the subject 14 can be acquired by observing the subject 14 with an external camera or analyzing the image data. Specifically, based on subtraction images of a plurality of image data acquired in a time-series manner, the display control unit 22 determines that there is body motion of the subject 14 with a large difference, and determines that there is no body motion of the subject 14 with a small difference. Alternatively, the display control unit 22 can determine the presence or absence of body motion by creating an average image from the plurality of image data and calculating a motion vector between the average image and each one of the plurality of image data.

With the body motion of the subject 14, the spatial statistical processing unit 18 performs the spatial statistical process in many cases. At that time, the time statistical processing unit 20 does not perform the time statistical process. It is particularly effective in the case of observing lung cancer in breathing body motion. This is because the time statistical process is not stabilized with the body motion of the subject 14. With the body motion of the subject 14, the spatial statistical processing unit 18 outputs the spatial statistical image based on the spatial statistical process. The display control unit 22 controls the display unit 24 to display the spatial statistical image output from the spatial statistical processing unit 18. The display unit 24 displays the spatial statistical image.

Without the body motion of the subject 14, the time statistical processing unit 20 performs the time statistical process. It is particularly effective in the case where long-time breath-holding with lung cancer is possible. This is because the time statistical process is stabilized without the body motion of the subject 14. Without the body motion of the subject 14, the time statistical processing unit 20 outputs the time statistical image based on the time statistical process. The time statistical processing unit 20 can perform the time statistical process excluding the image data with the body motion.

The display control unit 22 controls the display unit 24 to display the time statistical image output from the time statistical processing unit 20. The display unit 24 displays the time statistical image.

According to the embodiment, the radiographing system includes the radiation detection apparatus that detects radiation that passed through the subject 14 and outputs image data, the spatial statistical processing unit that acquires the average pixel value and variance value in a predetermined area of the image data, calculates the radiation quantum number and average energy, and performs the spatial statistical process, the time statistical processing unit that acquires the average pixel value and variance value in a plurality of image data in a time-series manner, calculates the radiation quantum number and average energy and performs the time statistical process, and the display unit that displays the spatial statistical image based on the spatial statistical information or the time statistical image based on the time statistical information.

Accordingly, the radiographing system can display statistical images based on a plurality of kinds of statistical processes. That is, the radiographing system can display a statistical image based on an appropriate statistical process in any situation.

### Second Embodiment

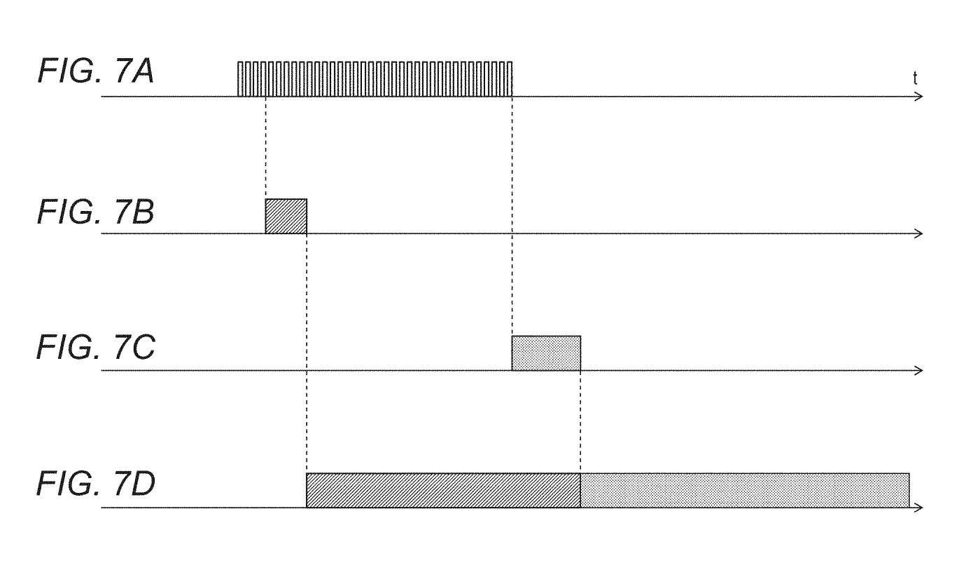

The sequence of statistical processes and display according to a second embodiment will be described with reference to FIGS. 7A, 7B, 7C, and 7D. The second embodiment is different from the first embodiment in that the spatial statistical processing unit 18 performs the spatial statistical process and the time statistical processing unit 20 performs the time statistical process at the same time.

FIG. 7A illustrates the timing for acquiring the image data output from the radiation detection apparatus 12. FIG. 7B illustrates the timing for acquiring the statistical image based on the spatial statistical process and the time statistical process. FIG. 7C illustrates the timing for acquiring the time statistical image based on the time statistical information. FIG. 7D illustrates the timing for displaying the images to be displayed on the display unit 24.

In the mode illustrated in FIG. 3 according to the first embodiment, the spatial statistical processing unit 18 calculates the average pixel value and variance value in an area of 100 pixels to estimate the radiation quantum number and average energy. In the second embodiment, the spatial statistical processing unit 18 performs the spatial statistical process and the time statistical processing unit 20 performs the time statistical process at the same time. Specifically, the spatial statistical processing unit 18 performs the spatial statistical process and the time statistical processing unit 20 performs the time statistical process in an area smaller than 100 pixels in one frame of image data in the mode illustrated in FIG. 3. The spatial statistical processing unit 18 and the time statistical processing unit 20 calculate the average pixel value and variance value in an area of 25 pixels in four frames of image data to estimate the radiation quantum number and average energy. Then, the spatial statistical processing unit 18 and the time statistical processing unit 20 output the statistical image based on the spatial statistical process and the time statistical process to the display control unit 22. The display control unit 22 controls the display unit 24 to display the statistical image based on the spatial statistical process and the time statistical process output from the time statistical processing unit 20. The display unit 24 displays the statistical image based on the spatial statistical process and the time statistical process.

As illustrated in FIG. 7C, upon completion of the time statistical process by the time statistical processing unit 20, the time statistical processing unit 20 outputs the time statistical image. The display control unit 22 controls the display unit 24 to display the time statistical image output from the time statistical processing unit 20. The display unit 24 displays the time statistical image.

At that time, as illustrated in FIG. 7D, the statistical image based on the spatial statistical process and the time statistical process first displayed on the display unit 24 is deleted, and the time statistical image based on the time statistical process is displayed on the display unit 24. For the statistical image based on the spatial statistical process and the time statistical process, the average pixel value and variance value are used in each predetermined area of the image data to estimate the radiation quantum number and average energy. Therefore, the time statistical image based on the time statistical process is higher in image resolution than the statistical image based on the spatial statistical process and the time statistical process. Accordingly, the statistical image based on the spatial statistical process and the time statistical process is replaced by the time statistical image.

As described above, the radiographing system can display the statistical image based on the plurality of kinds of statistical processes. The statistical image based on the spatial statistical process and the time statistical process is higher in image resolution than the spatial statistical image based on the spatial statistical process. This enables the operator to identify the constitutive substances of the subject 14 in a quick and correct manner.

### Third Embodiment

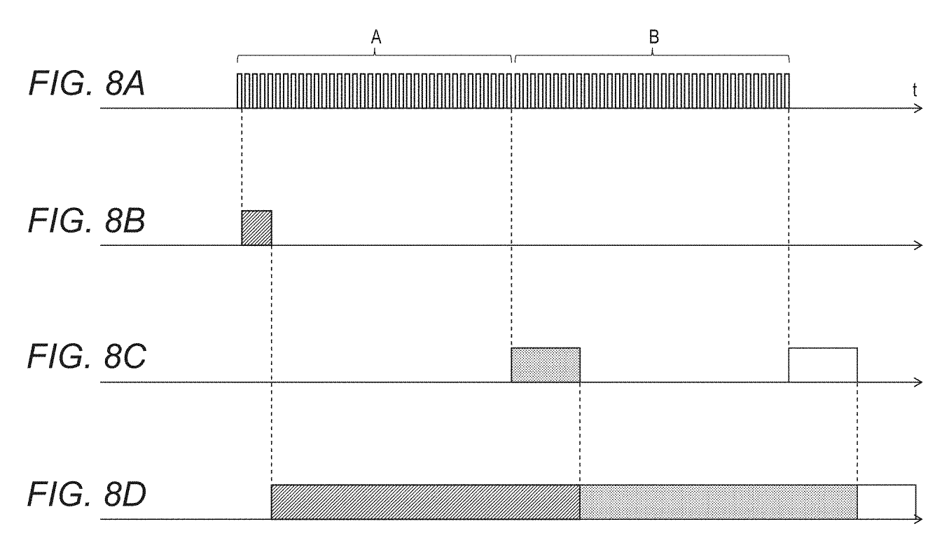

The sequence of statistical processes and display according to a third embodiment will be described with reference to FIGS. 8A, 8B, 8C, and 8D. The third embodiment is different from the first and second embodiments in that the time statistical processing unit 20 repeatedly performs the time statistical process.

FIG. 8A illustrates the timing for acquiring the image data output from the radiation detection apparatus 12. FIG. 8B illustrates the timing for acquiring the spatial statistical image based on the spatial statistical process. FIG. 8C illustrates the timing for acquiring the time statistical image based on the time statistical information. FIG. 8D illustrates the timing for displaying the images to be displayed on the display unit 24.

As illustrated in FIG. 8B, the spatial statistical processing unit 18 can perform the spatial statistical process with one image data, and once image data is output, the spatial statistical processing unit 18 immediately performs the spatial statistical process. At that time, as illustrated in FIG. 8C, the time statistical process performed by the time statistical processing unit requires a plurality of image data, and the time statistical processing unit 20 cannot perform the time statistical process.

Upon completion of the spatial statistical process by the spatial statistical processing unit 18, the spatial statistical processing unit 18 outputs the spatial statistical image based on the spatial statistical process. The display control unit 22 controls the display unit 24 to display the spatial statistical image output from the spatial statistical processing unit 18. The display unit 24 displays the spatial statistical image.

As illustrated in FIG. 8C, upon completion of the time statistical process by the time statistical processing unit 20, the time statistical processing unit 20 outputs the time statistical image based on the time statistical process. The display control unit 22 controls the display unit 24 to display the time statistical image output from the time statistical processing unit 20. The display unit 24 displays the time statistical image.

At that time, as illustrated in FIG. 8D, the spatial statistical image first displayed on the display unit 24 is deleted and the time statistical image is displayed on the display unit 24. For the spatial statistical image, the radiation quantum number and average energy are estimated using the average pixel value and variance value in each predetermined area of the image data, and therefore the time statistical image is higher in image resolution than the spatial statistical image. Therefore, in the embodiment, the spatial statistical image is replaced by the time statistical image on the display unit 24.

When the time statistical processing unit 20 repeatedly performs the time statistical process, the time statistical processing unit 20 outputs the time statistical image based on the time statistical process each time. Specifically, the time statistical processing unit 20 performs the time statistical process using the first output image data in a time range A, and outputs the time statistical image based on that time statistical process. Then, the time statistical processing unit 20 performs the time statistical process using the next output image data in a time range B, and outputs the time statistical image based on the time statistical process. The time range A and the time range B can overlap each other.

The display control unit 22 controls the display unit 24 to display the latest time statistical image output from the time statistical processing unit 20. The display unit 24 displays the latest time statistical image output from the time statistical processing unit 20.

Accordingly, the radiographing system can display the latest time statistical image. The operator can identify quickly the constitutive substances of the subject 14.

### Fourth Embodiment

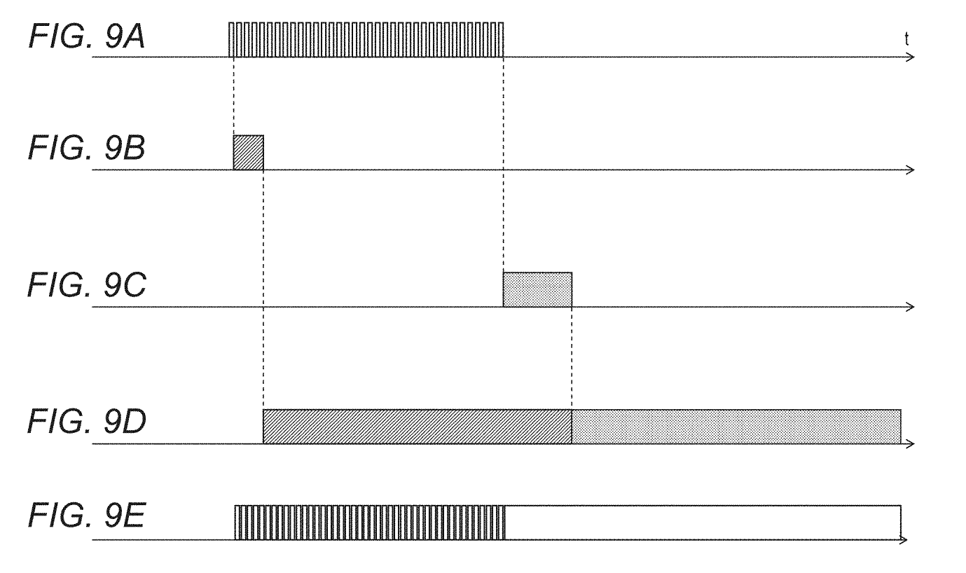

The sequence of statistical processes and display according to a fourth embodiment will be described with reference to FIGS. 9A, 9B, 9C, 9D, and 9E. The fourth embodiment is different from the first to third embodiments in that the statistical image based on the spatial statistical process or the time statistical process is displayed in colors and the radiation image based on the image data output from the radiation detection apparatus 12 is displayed in black and white.

FIG. 9A illustrates the timing for acquiring the image data output from the radiation detection apparatus 12. FIG. 9B illustrates the timing for acquiring the spatial statistical image based on the spatial statistical information. FIG. 9C illustrates the timing for acquiring the time statistical image based on the time statistical information. FIG. 9D illustrates the timing for displaying the statistical image to be displayed on the display unit 24. FIG. 9E illustrates the timing for displaying the radiation image to be displayed on the display unit 24.

FIGS. 9A to 9D are the same as FIGS. 6A to 6D, and detailed descriptions thereof will be omitted.

As illustrated in FIG. 9E, the display unit 24 displays the radiation image in black and white. In this case, the display unit 24 displays the radiation image each time the radiation detection apparatus 12 outputs image data. The display unit 24 first displays the radiation image.

Next, as illustrated in FIG. 9B, upon completion of the spatial statistical process by the spatial statistical processing unit 18, the spatial statistical processing unit 18 outputs the spatial statistical image based on the spatial statistical process. The display control unit 22 controls the display unit 24 to display the spatial statistical image output from the spatial statistical processing unit 18. The display unit 24 displays the spatial statistical image in colors. At that time, the display unit 24 displays the colored spatial statistical image and the black-and-white radiation image at the same time. When the radiation detection apparatus stops output of the image data, the display unit 24 displays and holds the last radiation image without updating the radiation image.

Then, as illustrated in FIG. 9C, upon completion of the time statistical process by the time statistical processing unit 20, the time statistical processing unit 20 outputs the time statistical image based on the time statistical process. The display control unit 22 controls the display unit 24 to display the time statistical image output from the time statistical processing unit 20. The display unit 24 displays the time statistical image in colors. At that time, the display unit 24 displays the colored time statistical image and the black-and-white radiation image at the same time.

Accordingly, the radiographing system can display the colored time statistical image and the black-and-white radiation image at the same time. The operator can observe the morphologic information and constitutive substances of the subject 14.

### Fifth Embodiment

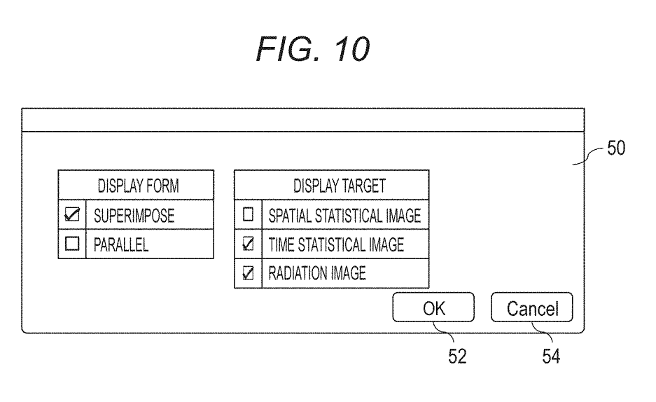

A fifth embodiment will be described with respect to FIGS. 10 to 13. The fifth embodiment is different from the first to fourth embodiments in controlling the display form of the image to be displayed on the display unit 24.

FIG. 10 illustrates a setting screen 50 (setting unit) for setting the display mode on the display unit 24. For the display mode, either superimposition or parallel can be selected. For items as display targets, the spatial statistical image, the time statistical image, and the radiation image can be selected. Referring to FIG. 10, for example, superimposition is selected as display mode, and the time statistical image and the radiation image are selected as display targets. The operator presses an execute button 52 to enable the selection. The operator presses a cancel button 54 to disable the selection. Accordingly, the display unit 24 displays the time statistical image and the radiation image in a superimposing manner as illustrated in FIG. 5.

Although not illustrated, when parallel is selected as display mode and the spatial statistical image and the radiation image are selected as display targets, the display unit 24 displays the spatial statistical image and the radiation image in parallel as illustrated in FIGS. 4A and 4B.

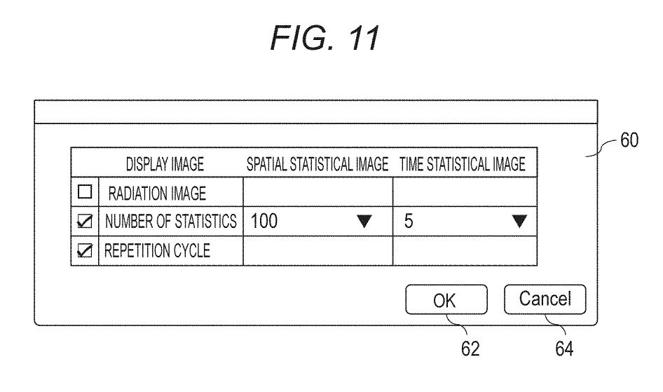

FIG. 11 illustrates a setting screen 60 (setting unit) for setting the statistical image to be displayed on the display unit 24. The display unit 24 displays the number of statistics of image data necessary for the time statistical process and the repetition cycle of the time statistical process. The time statistical processing unit 20 sets the number of statistics of image data necessary for the time statistical process and the repetition cycle. That is, the operator can set the number of statistics and the repetition cycle.

The operator presses an execute button 62 to enable the selection. The operator presses a cancel button to disable the setting. The number of image data necessary for the time statistical process can be set within a range of 10 to 200, for example. The repetition cycle of the time statistical process can be set within a range of 2 to 100, for example. In this case, the number of statistics is set to 100 and the repetition cycle is set to 5. That is, the display unit 24 displays the time statistical image having undergone the time statistical process using 100 image data. The display unit 24 updates and displays the time statistical image five times. Accordingly, the type of the image to be displayed can be set on the display unit 24, the number of image data to undergo the statistical process, and the repetition cycle of the statistical process.

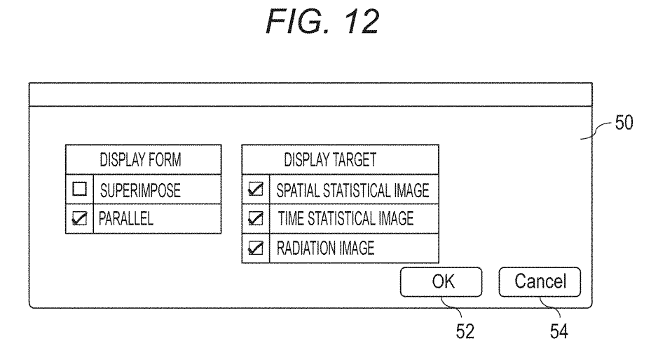

FIG. 12 illustrates the setting screen 50 (setting unit) for setting the display mode of the display unit 24. Referring to FIG. 12, parallel is selected as display mode and the spatial statistical image, the time statistical image, and the radiation image are selected as display targets. In this case, the display unit 24 displays the radiation image in black and white. Upon completion of the spatial statistical process by the spatial statistical processing unit 18, the spatial statistical processing unit 18 outputs the spatial statistical image based on the spatial statistical process. The display unit 24 displays the spatial statistical image. Upon completion of the time statistical process by the time statistical processing unit 20, the time statistical processing unit 20 outputs the time statistical image based on the time statistical process. The display unit 24 displays the time statistical image. In this way, the display unit 24 displays the spatial statistical image, the time statistical image, and the radiation image.

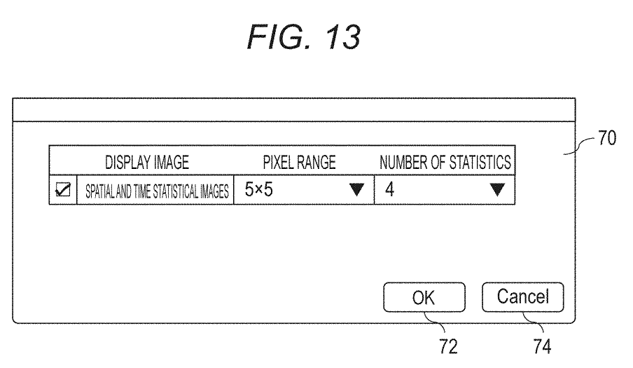

FIG. 13 illustrates a setting screen 70 (setting unit) for setting the spatial and time statistical image. The display unit 24 displays the pixel range for the spatial statistical process and the number of statistics for the time statistical process. The spatial statistical processing unit 18 sets the pixel range of image data necessary for the spatial statistical process. The time statistical processing unit 20 sets the number of statistics for image data necessary for the time statistical process. That is, the operator can set the pixel range for the spatial statistical process and the number of statistics for the time statistical process. The operator presses an execute button 72 to enable the settings. The operator presses a cancel button 74 to disable the settings. For example, the pixel range for the spatial statistical process can be set from 1×1 to 10×10.

When either the pixel range for the spatial statistical process or the number of statistics for the time statistical process is set, the display control unit can automatically set the other such that total predetermined pixels (for example, 100 pixels) can be achieved. Specifically, when the display control unit 22 sets the pixel range for the spatial statistical process to 10×10, the number of statistics for the time statistical process is set to 1. When the display control unit 22 sets the pixel range for the spatial statistical process to 5×5, the number of statistics for the time statistical process is set to 4. When the display control unit 22 sets the pixel range for the spatial statistical process to 2×2, the number of statistics for the time statistical process is set to 25.

Accordingly, the radiographing system can control the display mode of the image to be displayed on the display unit 24. The operator can observe the desired image.

### Other Embodiments

Embodiments can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-212127, filed Oct. 28, 2016, which is hereby incorporated by reference herein in its entirety.

What is claimed is:

1. A radiographing system comprising:
a radiation detection apparatus configured to detect radiation that passed through a subject and output image data;
a spatial statistical processing unit configured to acquire an average pixel value and a variance value of a predetermined pixel based on the image data and perform a spatial statistical process;
a time statistical processing unit configured to acquire an average pixel value and a variance value in a time-series manner based on a plurality of image data and perform a time statistical process; and
a display unit configured to display a spatial statistical image based on spatial statistical information that is a result of the spatial statistical process or a time statistical image based on time statistical information that is a result of the time statistical process.

2. The radiographing system according to claim 1, wherein the display unit displays the time statistical image after the display unit 24 displays the spatial statistical image.

3. The radiographing system according to claim 1, wherein the display unit displays either the spatial statistical image or the time statistical image on a radiation image based on the image data.

4. The radiographing system according to claim 1, wherein the display unit displays either the spatial statistical image or the time statistical image in parallel to the radiation image based on the image data.

5. The radiographing system according to claim 1, wherein the spatial statistical processing unit performs the spatial statistical process and the time statistical processing unit performs the time statistical process at the same time.

6. The radiographing system according to claim 1, wherein the spatial statistical processing unit repeatedly performs the spatial statistical process each time outputs the spatial statistical image based on the spatial statistical process.

7. The radiographing system according to claim 1, wherein the time statistical processing unit repeatedly performs the time statistical process and each time outputs the time statistical image based on the time statistical process.

8. The radiographing system according to claim 1, wherein the display unit displays the spatial statistical image or the time statistical image in colors.

9. The radiographing system according to claim 1, further comprising a control unit configured to control the spatial statistical process performed by the spatial statistical processing unit and the time statistical process performed by the time statistical processing unit based on body motion of the subject.

10. The radiographing system according to claim 1, wherein the time statistical processing unit sets the number of statistics of image data necessary for the time statistical process.

11. The radiographing system according to claim 1, wherein the time statistical processing unit sets a repetition cycle of the time statistical process.

12. The radiographing system according to claim 1, wherein the spatial statistical processing unit sets a pixel range of image data necessary for the spatial statistical process.

13. A radiation display method comprising the steps of:
detecting radiation that passed through a subject;
outputting image data;
acquiring an average pixel value and a variance value of a predetermined pixel based on the image data and performing a spatial statistical process;
acquiring an average pixel value and a variance value in a time-series manner based on a plurality of image data and performing a time statistical process; and
displaying a spatial statistical image based on spatial statistical information that is a result of the spatial statistical process or a time statistical image based on time statistical information that is a result of the time statistical process.

14. A computer-readable storage medium storing computer-executable instructions for causing a computer to execute a radiation display method, the radiation display method comprising:
detecting radiation that passed through a subject;
outputting image data;
acquiring an average pixel value and a variance value of a predetermined pixel based on the image data and performing a spatial statistical process;
acquiring an average pixel value and a variance value in a time-series manner based on a plurality of image data and performing a time statistical process; and
displaying a spatial statistical image based on spatial statistical information that is a result of the spatial statistical process or a time statistical image based on time statistical information that is a result of the time statistical process.
